(19) United States
(12) Patent Application Publication
(10) Pub. No.: US 2026/0188728 A1
(43) Pub. Date: Jul. 2, 2026

(54) METHOD FOR PREPARING SULFIDE BASED SOLID ELECTROLYTE

(71) Applicants: Hyundai Motor Company, Seoul (KR); Kia Corporation, Seoul (KR); SEOUL NATIONAL UNIVERSITY R&DB FOUNDATION, Seoul (KR)

(72) Inventors: Seong Hyeon Choi, Hwaseong (KR); Sang Soo Lee, Hwaseong (KR); So Young Kim, Hwaseong, Gyeonggi-do (KR); Sun Ho Choi, Hwaseong (KR); Wo Dum Jung, Hwaseong (KR); Jae Young Kim, Hwaseong (KR); Yong Sub Yoon, Hwaseong (KR); Geun Hyeong Shin, Hwaseong (KR); Jae Ho Lee, Seoul (KR); Da Woon Kim, Seoul (KR); In Chung, Seoul (KR)

(21) Appl. No.: 19/300,463

(22) Filed: Aug. 14, 2025

(30) Foreign Application Priority Data
Dec. 31, 2024 (KR) 10-2024-0202720

(51) Int. Cl. H01M 10/0562; H01M 4/02; H01M 4/131; H01M 4/134; H01M 4/38; H01M 4/505; H01M 4/525; H01M 4/64; H01M 10/0525

(52) U.S. Cl. CPC H01M 10/0562; H01M 4/131; H01M 4/134; H01M 4/382; H01M 4/505; H01M 4/525; H01M 4/64; H01M 10/0525; H01M 2004/027; H01M 2004/028; H01M 2300/008

(57) ABSTRACT

Provided is a method for preparing a sulfide-based solid electrolyte. An amorphous sulfide powder is first prepared from lithium sulfide, a phosphorous-containing material, and an optional halogen source. The powder is then densified by spark-plasma sintering at 360-600 C under 1-140 MPa for 1-15 minutes, yielding a crystalline argyrodite structure. Also provided is a crystalline sulfide-based solid electrolyte and an all-solid-state secondary battery prepared by the method.

### CROSS-REFERENCE TO RELATED APPLICATION

This application claims the benefit of Korean Patent Application No. 10-2024-0202720, filed in the Korean Intellectual Property Office on Dec. 31, 2024, the entire contents of which are incorporated herein by reference.

### BACKGROUND

### Technical Field

The present disclosure relates to a method for preparing sulfide based solid electrolyte.

### Background

An all solid state battery, in which the liquid electrolyte positioned between the cathode and anode of a conventional lithium secondary battery is replaced with a solid electrolyte, has attracted considerable attention as a next generation battery, because the all solid state battery is safe without the risk of explosion and had a higher density than that of a conventional battery. The solid electrolyte employed in the all-solid state battery is a material in a solid phase, which conducts lithium ions in a battery, and has higher ion conductivity at the same level as that of an existing electrolyte solution applied to the lithium secondary battery. Core materials constituting the solid electrolyte include a polymer, a sulfide, or an oxide. Among them, a sulfide-based solid electrolyte having higher softness and higher ion conductivity has been evaluated as being appropriate to preparing a large-scale battery requiring a higher capacity.

To improve the crystallinity of the sulfide-based solid electrolyte, high-temperature heat treatment is performed together. However, furnace temperature gradients can hinder uniform crystallization, and the prolonged heat-treatment type-typically several to several tens of hours-significantly lowers process efficiency.

### SUMMARY

The present disclosure has been made to solve the above-mentioned problems occurring in the existing technologies while advantages achieved by the existing technologies are maintained intact.

An embodiment of the present disclosure provides a method for preparing azirodite-based solid electrolyte for an all solid state battery, capable of exhibiting excellent ion conductivity by improving the crystallinity of amorphous sulfide-based solid electrolyte through a spark plasma sintering process performed for a shorter period, without a heat treatment process for a longer time period, to improve the output characteristic, the lifespan characteristic, and the C-rate characteristic of the all solid state battery.

The technical problems to be solved by the present disclosure are not limited to the aforementioned problems, and any other technical problems not mentioned herein will be clearly understood from the following description by those skilled in the art to which the present disclosure pertains.

According to an embodiment of the present disclosure, there is provided a method for preparing a sulfide-based solid electrolyte.
(1) The present disclosure provides a method for preparing a sulfide-based solid electrolyte, which comprises synthesizing an amorphous sulfide-based solid electrolyte (S1), and obtaining a crystalline sulfide-based solid electrolyte by performing a spark plasma sintering process with respect to the amorphous sulfide-based solid electrolyte synthesized in S1 (S2), wherein, in S2, the spark plasma sintering process is performed at a reaction temperature of 360° C. or more and 600° C. or less.
(2) The present disclosure provides a method for preparing a sulfide-based solid electrolyte of the (1), wherein, in S2, the spark plasma sintering process is performed at a reaction temperature of 400° C. or more and 500° C. or less.
(3) The present disclosure provides a method for preparing a sulfide-based solid electrolyte of the (1) or (2), wherein, in S2, the spark plasma sintering process is performed at pressure of 1 MPa or more and 150 MPa or less.
(4) The present disclosure provides a method for preparing a sulfide-based solid electrolyte of one of the (1) to (3), wherein, in S2, the spark plasma sintering process is performed at pressure of 20 MPa or more and 90 MPa or less.
(5) The present disclosure provides a method for preparing a sulfide-based solid electrolyte of one of the (1) to (4), wherein, in S2, the spark plasma sintering process is performed for a time period of one minute or more and 15 minutes or less.
(6) The present disclosure provides a method for preparing a sulfide-based solid electrolyte of one of the (1) to (5), wherein S1 is to perform a milling process for a source material, which comprises a lithium sulfide, a sulfide-based source material, and a halogen compound, to form powders, and perform a mixing process and a heat-treatment process for the powders.
(7) The present disclosure provides a method for preparing a sulfide-based solid electrolyte of one of the (1) to (6), wherein the crystalline sulfide-based solid electrolyte comprises an azirodite-type sulfide-based solid electrolyte.
(8) The present disclosure provides a method for preparing a sulfide-based solid electrolyte of one of the (1) to (7), wherein the crystalline sulfide-based solid electrolyte comprises a sulfide-based solid electrolyte represented by following Chemical formula 1,

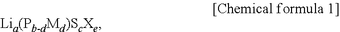

in which in Chemical formula 1,
‘M’ is at least one selected from the group consisting of Sb, Sn, Ge, Si, Nb, Ni, Ga, and Al,
‘X’ is at least one selected from the group consisting of F, Cl, Br, and I,
3.0≤a≤8.0, 0<b≤2.0, 2.0≤c≤7.0, 0≤d≤1.0, and 0<e≤2.0, and
‘b’ is greater than ‘d’.
(9) The present disclosure provides a method for preparing a sulfide-based solid electrolyte of one of the (1) to (8), wherein the crystalline sulfide-based solid electrolyte comprises a sulfide-based solid electrolyte represented by following Chemical formula 2,

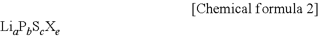

in which, in Chemical formula 2,
‘M’ is at least one selected from Sb, Sn, Ge, Si, Nb, Ni, Ga, and Al,
V
X′ is at least one selected from F, Cl, Br and I, and

$$4.5 \leq a \leq 7.0 , 0.7 \leq b \leq 1.8 , 4.0 \leq c \leq 6. , and 0.5 \leq e \leq 2.0 .$$

As discussed, the method and system suitably include use of a controller or processer.

A crystalline sulfide-based solid electrolyte having an argyrodite crystal structure, wherein the electrolyte is obtained by subjecting an amorphous sulfide-based solid electrolyte precursor to a spark-plasma-sintering (SPS) process carried out at a temperature of about 360° C. to about 600° C., under a pressure of about 1 MPa to about 150 MPa, for 1 minute to 15 minutes.

The SPS process may be carried out at a reaction temperature of about 400° C. to about 500° C.

The SPS process may be carried out at a pressure of about 2 MPa to about 90 MPa.

The electrolyte may be represented by following Chemical formula 1,

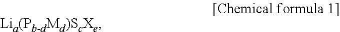

in which in Chemical formula 1,
‘M’ is at least one selected from the group consisting of Sb, Sn, Ge, Si, Nb, Ni, Ga, and Al,
‘X’ is at least one selected from the group consisting of F, Cl, Br, and I,
3.0≤a≤8.0, 0<b≤2.0, 2.0≤c≤7.0, 0≤d≤1.0, and 0<e≤2.0, and
‘b’ is greater than ‘d’.

The electrolyte may be represented by following Chemical formula 2,

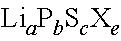

in which, in Chemical formula 2,
‘M’ is at least one selected from Sb, Sn, Ge, Si, Nb, Ni, Ga, and Al,
‘X’ is at least one selected from F, Cl, Br and I, and

$$4.5 \leq a \leq 7.0 , 0.7 \leq b \leq 1.8 , 4.0 \leq c \leq 6. , and 0.5 \leq e \leq 2.0 .$$

The electrolyte may comprise Li₆PS₅Cl.

An all-solid-state secondary battery includes an anode current collector, a solid-electrolyte later that includes the crystalline sulfide-based solid electrolyte according to claim 10, and a cathode active-material layer disposed in contact with the solid-electrolyte layer.

The cathode-active material layer may include LiNi_{0.8}CO_{0.1}Mn_{0.1}O₂.

The solid-electrolyte layer and the cathode active-material layer may be laminated by pressing at about 45 MPa.

The battery may be configured as a half-cell that further includes a lithium metal foil anode.

An initial efficiency (discharging capacity/charging capacity) of about 90% or greater is obtained.

### BRIEF DESCRIPTION OF THE DRAWINGS

The above and other objects, features and advantages of the present disclosure will be more apparent from the following detailed description taken in conjunction with the accompanying drawings:

FIG. 1 is a schematic view illustrating a spark plasma sintering process, according to some embodiments of the present disclosure;

FIG. 2 is a schematic view illustrating a reaction chamber, according to some embodiments of the present disclosure;

FIG. 3 is a cross-sectional view illustrating a unit cell, according to some embodiments of the present disclosure;

FIG. 4A illustrates an XRD spectrum obtained by measuring sulfide-based solid electrolytes, which are prepared according to some embodiments and a comparative example, through an X-ray diffraction analysis manner in a 20 range between 10° to 60°;

FIG. 4B illustrates an XRD spectrum obtained by measuring sulfide-based solid electrolytes, which are prepared according to some embodiments and a comparative example, through an X-ray diffraction analysis manner in a 20 range between 10° to 60°;

FIG. 4C illustrates an XRD spectrum obtained by measuring sulfide-based solid electrolytes, which are prepared according to some embodiments and a comparative example, through an X-ray diffraction analysis manner in a 20 range between 10° to 60°;

FIG. 4D illustrates an XRD spectrum obtained by measuring sulfide-based solid electrolytes, which are prepared according to some embodiments and a comparative example, through an X-ray diffraction analysis manner in a 20 range between 10° to 60°;

FIG. 5 is a graph showing a charging/discharging characteristic of a half-cell prepared using a sulfide-based solid electrolyte prepared according to a comparative example;

FIGS. 6A and 6B are graphs showing an evaluation result for an output characteristic of a half-cell prepared using sulfide-based solid electrolytes which are prepared according to some embodiments and a comparative example;

FIGS. 6C and 6D are graphs showing an evaluation result for a lifespan characteristic of a half-cell prepared using sulfide-based solid electrolytes prepared according to some embodiments and a comparative example; and

FIGS. 6E and 6F are graphs showing an evaluation result for a C-rate characteristic of a half-cell prepared using sulfide-based solid electrolytes prepared according to some embodiments and a comparative example.

### DETAILED DESCRIPTION

Hereinafter, the present disclosure will be described in more detail for the understanding of the present disclosure.

Terms or words used in the present specification and the claims should not be interpreted as commonly-used dictionary meanings, but be interpreted as to be relevant to the technical scope of the present disclosure based on the fact that the inventor may properly define the concept of the terms to explain the present disclosure in best ways.

The term “amorphous sulfide-based solid electrolyte” herein refers to a lithium-sulfide containing a solid electrolyte that shows no long-range crystal order when examined by X-ray diffraction, typically obtained directly after mechanical milling or solution synthesis before any heat treatment.

The term “crystalline sulfide-based solid electrolyte” herein refers to a sulfide solid electrolyte whose lithium-ion-conducting phase exhibits a well-defined crystal lattice detectable by distinct diffraction peaks.

The term “initial efficiency” herein refers to the ratio of the first-cycle discharge capacity to the first-cycle charge capacity of a cell.

The term “half-cell” herein refers to an electrochemical test cell that pairs a working electrode with a lithium-metal counter/reference electrode.

The present disclosure provides a method for preparing a sulfide-based solid electrolyte and a solid electrolyte.

According to an embodiment of the present disclosure, the method for preparing the sulfide-based solid electrolyte comprises the steps for synthesizing an amorphous sulfide-based solid electrolyte (S1), and obtaining a crystalline sulfide-based solid electrolyte by performing a spark plasma sintering (SPS) process with respect to the amorphous sulfide-based solid electrolyte (S2), In S2, the SPS process may be performed at a reaction temperature of 360° C. or more and 600° C. or less.

According to an embodiment of the present disclosure, S1 is the step for synthesizing the amorphous sulfide-based solid electrolyte, and the manner for synthesizing the amorphous sulfide-based solid electrolyte may be performed within the scope of well-known manners. More specifically, S1 is the step for performing a milling process for a source material, which comprises a lithium sulfide, a sulfide-based source material, and a halogen compound, to form powders, and performing a mixing process and a heat-treatment process for the powders. The milling process may be performed within the scope of a well-known manner. Specifically, the milling process may comprise a ball milling process, a planet ball milling process, a vibration milling process, or a wet-synthesizing process. In addition, the heat-treatment process may be performed within the scope of a well-known manner. Specifically, the heat-treatment process may comprise a vacuum heat-treatment process. The heat-treatment process may be performed under an inert-gas atmosphere to prevent a side reaction. In addition, the lithium sulfide may be lithium sulfide (Li₂S), and the sulfide-based source material may be phosphorus sulfide such as P₂S₃, P₂S₅, P₄S₃, PAS₅, and P₄S₁₀. Specifically, the sulfide-based source material may be phosphorus pentasulfide (P₂S₅). In addition, the sulfide-based source material may further comprise a substituting element. In this case, the substituting element may be at least one selected from the group consisting of As, Ge, Ga, Sb, Si, Sn, Al, In, Ti, V, Nb, Ta, Se, and Te. In addition, the halogen compound may be lithium bromide, lithium chloride, iodide and lithium, or a combination thereof.

According to an embodiment of the present disclosure, S2 is the step for synthesizing the amorphous sulfide-based solid electrolyte synthesized in S1 into a high crystalline sulfide-based solid electrolyte, which is performed through the SPS process.

As described in Background art, a sintering process is typically performed through high-temperature heat treatment to improve the crystallinity of sulfide-based solid electrolyte. However, a high crystalline sulfide-based solid electrolyte having uniform crystallinity may not be obtained due to a temperature gradient of a furnace during the high-temperature treatment. In addition, the sintering process requires heat treatment for a longer time period ranging from several hours to tens of hours thereby degrading lower processability. However, according to an embodiment of the present disclosure, in the method for preparing the solid electrolyte, an azirodite-type sulfide-based solid electrolyte having uniform crystallinity and excellent ion conductivity may be obtained by performing only the SPS process for a shorter time period, without the conventional high-temperature heat treatment performed for the longer time period.

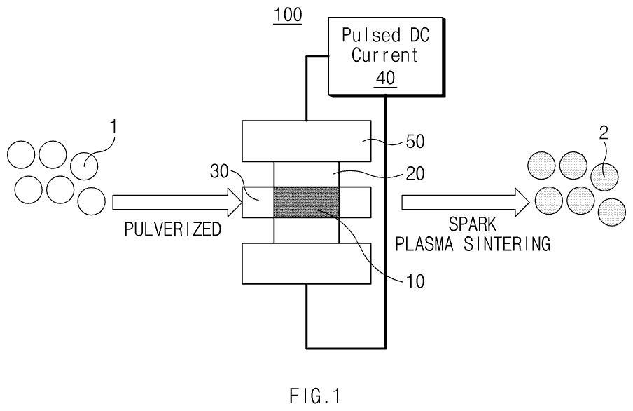

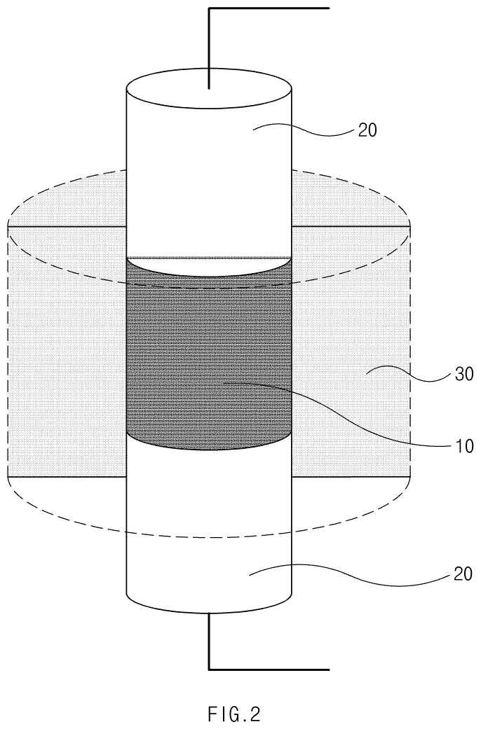

According to an embodiment of the present disclosure, specifically, as illustrated in FIG. 1, S2 may be performed by pulverizing the amorphous sulfide-based solid electrolyte 1 synthesized in S1, introducing the pulverized amorphous sulfide-based solid electrolyte 1 in a reaction chamber 10 of an SPS processing device 100, setting internal pressure of the reaction chamber 10 using a hydraulic press 50, and applying discharge plasma to a high-frequency power supply system 40. The pulverizing process may be within the scope of a well-known manner. Specifically, the pulverizing process may be performed through manners such as a ball milling manner, a jet milling manner, or a bead milling manner. As illustrated in FIGS. 1 and 2, the SPS processing device 100 may comprise the reaction chamber 10, a punch 20 making contact with an upper portion and a lower portion of the reaction chamber 10, a mold 30 to surround a side surface of the upper portion of the reaction chamber 10 while making contact with the side surface of the upper portion of the reaction chamber 10, the high-frequency power supply system 40, and the hydraulic press 50. The punch 20 maintains pressure generated from the hydraulic press 50 while making contact with the reaction chamber 10 and transfers heat and a high-frequency current, which is generated from the high-frequency power supply system 40, into the reaction chamber 10. The punch 20 may be employed within the scope of a well-known manner. Specifically, the punch 20 may be a graphite punch. The mold 30 maintains the side surface of the reaction chamber 10 and the shape of the reaction chamber 10 to maintain the shape of a reactant, thereby blocking the reaction chamber 10 from an external environment. The mold 30 may be employed within the scope of a well-known manner. Specifically, the mold 30 may be a graphite mold. In addition, the high-frequency power supply system 40 generates high-frequency discharge plasma during the SPS process. In addition, the hydraulic press 50 adjusts the internal pressure of the reaction chamber 10.

According to an embodiment of the present disclosure, in S2, the SPS process may be performed under the condition of a reaction temperature of 360° C. or more and 600° C. or less. Specifically, the SPS process may be performed under the condition of the reaction temperature of 360° C. or more, 362° C. or more, 364° C. or more, 366° C. or more, 368° C. or more, 370° C. or more, 372° C. or more, 374° C. or more, 376° C. or more, 378° C. or more, 380° C. or more, 382° C. or more, 384° C. or more, 386° C. or more, 388° C. or more, 390° C. or more, 392° C. or more, 394° C. or more, 396° C. or more, 398° C. or more, or 400° C. or more, and may be performed under the condition of the reaction temperature condition of 600° C. or less, 596° C. or less, 592° C. or less, 588° C. or less, 584° C. or less, 580° C. or less, 576° C. or less, 572° C. or less, 568° C. or less, 564° C. or less, 560° C. or less, 556° C. or less, 548° C. or less, 544° C. or less, 540° C. or less, 536° C. or less, 532° C. or less, 528° C. or less, 524° C. or less, 520° C. or less, 516° C. or less, 512° C. or less, 508° C. or less, 508° C. or less, or 500° C. or less. When the SPS process is performed within the above reaction time range, a sufficient amount of thermal energy is transferred into the amorphous sulfide-based solid electrolyte, thereby obtaining the azirodite-based solid electrolyte to prevent foreign substances from being generated and to have a stabler crystal structure, even if the SPS process is performed for the shorter time period. Meanwhile, when the reaction temperature exceeds 600° C., as the crystallinity of the sulfide-based solid electrolyte is degraded due to a higher volatile characteristic, the ion conductivity of the solid electrolyte may be lowered.

According to an embodiment of the present disclosure, in S2, the SPS process may be performed under a condition of pressure of 1 MPa or more and 150 MPa or less. Specifically, the SPS be performed under the condition of pressure of 1 MPa or more, 2 MPa or more, 3 MPa or more, 4 MPa or more, 5 MPa or more, 6 MPa or more, 7 MPa or more, 8 MPa or more, 9 MPa or more, 10 MPa or more, 11 MPa or more, 12 MPa or more, 13 MPa or more, 14 MPa or more, 15 MPa or more, 16 MPa or more, 17 MPa or more, 18 MPa or more, 19 MPa or more, or 20 MPa or more, and may be performed under a condition of pressure of 150 MPa or less, 147 MPa or less, 144 MPa or less, 141 MPa or less, 138 MPa or less, 135 MPa or less, 132 MPa or less, 129 MPa or less, 126 MPa or less, 123 MPa or less, 120 MPa or less, 117 MPa or less, 114 MPa or less, 111 MPa or less, 108 MPa or less, 105 MPa or less, 102 MPa or less, 99 MPa or less, 96 MPa or less, 93 MPa or less, or 90 MPa or less. When the SPS process is performed within the pressure range, a sufficient amount of pressure is applied into the amorphous sulfide-based solid electrolyte, thereby obtaining the high crystalline azirodite-based solid electrolyte to prevent foreign substances from being generated and to have a stabler crystal structure, even if the SPS process is performed for the shorter time period.

According to an embodiment of the present disclosure, in S2, the SPS process may be performed for a time period of 1 minute or more and 15 minutes or less. Specifically, the SPS process may be performed for a time period of 1 minute or more, 2 minutes or more, 3 minutes or more, 4 minutes or more, 5 minutes or more, and may be performed for a time period of 15 minutes or less, 14 minutes or less, 13 minutes or less, 12 minutes or less, 11 minutes or less, 10 minutes or less, 9 minutes or less, or 8 minutes or less. When the SPS process is performed within the time range, the azirodite-based solid electrolyte has a stable crystal structure and has higher crystallinity.

According to an embodiment of the present disclosure, the solid electrolyte may be a sulfide-based solid electrolyte for an all-solid-state battery. Specifically, the solid electrolyte may be a sulfide-based solid electrolyte for an all-solid-state battery to which the SPS process is applied.

According to an embodiment of the present disclosure, the sulfide-based solid electrolyte may comprise at least one selected from the group consisting of an LPS-based sulfide-based solid electrolyte, a Thio-LISICON-based sulfide-based solid electrolyte, an LGPS-based sulfide-based solid electrolyte, and an azirodite-based solid electrolyte. For example, the sulfide-based solid electrolyte may comprise at least one selected from the group consisting of Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (‘m’ and ‘n’ are positive numbers, and ‘Z’ is one among Ge, Zn, and Ga), Li₂S—GeS₂, Li₂S—SiS₂—Li₃PO₄, Li₂S—SiS₂-LixMOy (‘x’ and ‘y’ are positive numbers, and ‘M’ is one among P, Si, Ge, B, Al, Ga, and In), Li₃PS₄, LizP₃S₁₁, Li₆PS₅Cl, Li_{5.5}PS_{4.5}Cl_{1.5}, Li₆PS₅Cl_{0.5}br_{0.5}, and Li₁₀GeP₂S₁₂. Specifically, the sulfide-based solid electrolyte may comprise at least one selected from the group consisting of Li₆PS₅Cl, Li_{5.8}PS_{4.8}Cl_{1.2}, Li_{5.5}PS_{4.5}Cl_{1.5}, and Li₆PS₅Cl_{0.5}br_{0.5}. More specifically, the sulfide-based solid electrolyte may comprise at least one selected from the group consisting of the Li₆PS₅Cl, Li_{5.8}PS_{4.8}Cl_{1.2} and Li_{5.5}PS_{4.5}Cl_{1.5}.

According to an embodiment of the present disclosure, the sulfide-based solid electrolyte may comprise a crystalline sulfide-based solid electrolyte. Specifically, the crystalline sulfide-based solid electrolyte may comprise at least one selected from the group consisting of an LGPS-based sulfide-based solid electrolyte and an azirodite-based solid electrolyte. More specifically, the sulfide-based solid electrolyte may comprise an azirodite-based solid electrolyte.

According to an embodiment of the present disclosure, the crystalline sulfide-based solid electrolyte may comprise the sulfide-based solid electrolyte represented by Chemical formula 1 or Chemical formula 2.

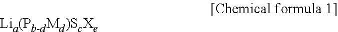

In Chemical formula 1,
‘M’ is at least one selected from Sb, Sn, Ge, Si, Nb, Ni, Ga, and Al,
‘X’ is at least one selected from F, Cl, Br and I,
3.0≤a≤8.0, 0<b≤2.0, 2.0≤c≤7.0, 0≤d≤1.0, and 0<e≤2.0, and ‘b’ is greater than ‘d’.

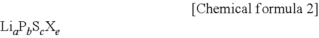

In Chemical formula 2,
‘M’ is at least one selected from Sb, Sn, Ge, Si, Nb, Ni, Ga, and Al,
‘X’ is at least one selected from F, Cl, Br and I,

$$4.5 \leq a \leq 7.0 , 0.7 \leq b \leq 1.8 , 4.0 \leq c \leq 6. , and 0.5 \leq e \leq 2.0 .$$

The present disclosure provides an all-solid-state battery comprising the soiled electrolyte.

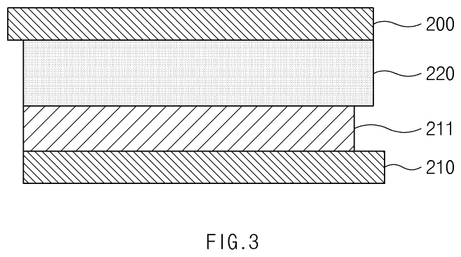

According to an embodiment of the present disclosure, the all-solid-state battery may comprise an anode, a solid electrolyte layer, and a cathode. Specifically, the all-solid-state battery may comprise a unit cell. According to the present disclosure, the all-solid-state battery may refer to the unit cell and may also refer to an all-solid state battery formed by stacking a plurality of unit cells. The unit cell may be a structure formed by sequentially stacking an anode current collector, the solid electrolyte layer, and the cathode. Specifically, as illustrated in FIG. 3, the all-solid-state battery may be a structure formed by sequentially an anode current collector 200, a solid electrolyte layer 220, a cathode active material layer 211, and a cathode current collector 210.

According to an embodiment of the present disclosure, the cathode current collector 210 may comprise a metal having high conductivity, without being specially limited, as long as the cathode current collector 210 easily adheres to a cathode active material layer and has no reactivity in a voltage range of the battery. Specifically, the cathode current collector may be stainless steel, aluminum, nickel, titanium, fired carbon, or aluminum or stainless-steel surface-treated with carbon, nickel, titanium, or silver. In addition, the cathode current collector may typically have a thickness ranging from 10 μm to 20 μm, and may be used in various forms, such as a film, a sheet, a foil, a net, a porous body, a foam, and a nonwoven fabric.

According to an embodiment of the present disclosure, the cathode active material layer 211 may selectively comprise a solid electrolyte, a binder, and a conductive material, together with the cathode active material.

According to an embodiment of the present disclosure, the cathode active material may be a lithium metal oxide allowing intercalation and deintercalation with lithium. Specifically, the lithium metal oxide may be a lithium metal oxide comprising at least one metal selected from the group consisting of cobalt, manganese, nickel, and iron. More specifically, the lithium metal oxide may be at least one selected from the group consisting of a lithium-manganese oxide, a lithium-cobalt oxide, a lithium-nickel oxide, a lithium-nickel-manganese oxide, a lithium-nickel-cobalt oxide, a lithium-manganese-cobalt oxide, and a lithium-nickel-cobalt-manganese oxide. More specifically, the lithium metal oxide may be at least one selected from the group consisting of LiMnO₂, LiMn₂O, LiCoO₂, LiNiO₂, LiNi_{1-Y}Mn_{Y}O₂ (0<Y<1), LiNi_{1-Y}CO_{Y}O₂ (0<Y<1), LiMn_{2-z}Co₂O₄ (0<Z<2), Li(Ni_{P}Co_{Q}Mn_{R})O₂ (0<P<1, 0<Q<1, 0<R<1, and P+Q+R=1), and Li(Ni_{P}Co_{Q}Mn_{R})O₄ (0<P<2, 0<Q<2, 0<R<2, and P+Q+R=2). Among them, the lithium metal oxide may be at least one selected from the group consisting of LiNi_{0.6}Mn_{0.2}Co_{0.2}O₂, LiNi_{0.34}Mn_{0.33}Co_{0.33}O₂, LiNi_{0.5}Mn_{0.3}Co_{0.2}O₂, LiNi_{0.7}Mn_{0.15}Co_{0.15}O₂. LiNi_{0.8}Mn_{0.1}Co_{0.1}O₂, and LiNi_{0.8}Mn_{0.15}Co_{0.05}O₂ to improve the capacity characteristics and stability of the all solid state battery.

According to an embodiment of the present disclosure, the lithium metal oxide may be doped with a transition metal. Specifically, the doping element may comprise at least one selected from the group consisting of Al, Mo, Nb, K, Cl, Na, Ti, Mg, Ru, Ta, Zr, W, Ti, Y, and B—. Specifically, the lithium metal oxide may comprise a lithium transition metal composite oxide represented by following Chemical formula 3.

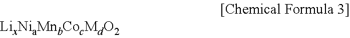

In Chemical formula 3,
‘M’ comprises at least selected from the group consisting of Al, Mo, Nb, K, Cl, Na, Ti, Mg, Ru, Ta, Zr, W, Ti, Y, and B—.

$$\begin{matrix}0.9 < x < 1.3 , 0 < a < 1 , 0 < b < 1 , 0 < c < 1 , 0 \leq d < 0.2 , and \\ a + b + c + d = 1.\end{matrix}$$

Specifically, in Chemical formula 3, ‘a’ may be greater than 0, 0.1 or more, 0.2 or more, 0.3 or more, 0.4 or more, 0.5 or more, 0.6 or more, or 0.7 or more, and may be less than 1, 0.95 or less, 0.9 or less, or 0.85 or less. In Chemical formula 3, ‘b’ may be greater than 0, 0.01 or more, 0.02 or more, 0.03 or more, 0.04 or more, 0.05 or more, 0.06 or more, 0.07 or more, 0.08 or more, 0.09 or more, and less than 1, 0.9 or less, 0.8 or less, 0.7 or less, 0.6 or less, 0.5 or less, 0.4 or less, 0.3 or less, or 0.2 or less. In addition, in Chemical formula 3, ‘c’ may be greater than 0, 0.01 or more, 0.02 or more, 0.03 or more, 0.04 or more, 0.05 or more, 0.06 or more, 0.07 or more, 0.08 or more, 0.09 or more, and less than 1, 0.9 or less, 0.8 or less, 0.7 or less, 0.6 or less, 0.5 or less, 0.4 or less, 0.3 or less, or 0.2 or less. In addition, in Chemical formula 3, d′ may be greater than 0, 0.01 or more, 0.02 or more, 0.03 or more, 0.04 or more, 0.05 or more, 0.06 or more, 0.07 or more, 0.08 or more, 0.09 or more, and less than 0.2, 0.19 or less, 0.18 or less, 0.17 or less, 0.16 or less, 0.15 or less, 0.14 or less, 0.13 or less, 0.12 or less, 0.11 or less.

According to one embodiment of the present disclosure, the lithium metal oxide may comprise a coating layer, and the coating layer may be formed on the surface of the lithium metal oxide. The coating layer may comprise a Li-M-O solid solution (M is at least one selected from Al, Mo, Nb, K, Cl, Na, Ti, Mg, Ru, Ta, Zr, W, Ti, Y, and B—) on the surface of the lithium metal oxide. In addition, the Li-M-O solid solution may comprise at least one selected from among Li—Nb—O, Li—Co—O, and Li—Ti—O. The Li-M-O solid solution may specifically comprise at least one selected from among LiNbO₂, LiNbO₃, LiCoO₂, and Li₂TiO₃, and more specifically, may comprise at least one selected from LiNbO₃ and LiCoO₂. In this case, the coating layer comprising the Li-M-O solid solution has excellent lithium-ion conductivity and excellent electronic conductivity, thereby realizing an all-solid battery having a small internal resistance.

According to an embodiment of the present disclosure, the coating layer comprised in the lithium metal oxide above may be a solid electrolyte coating layer. The solid electrolyte may comprise a material having lithium-ion conductivity. Specifically, the solid electrolyte may comprise at least one selected from the group consisting of an oxide-based solid electrolyte, a sulfide-based solid electrolyte, a polymer electrolyte, and a combination thereof. More specifically, the solid electrolyte may comprise a sulfide-based solid electrolyte. In addition, the solid electrolyte may comprise a sulfide-based solid electrolyte represented by following Chemical formula 4.

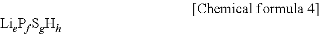

In Chemical formula 4, ‘X’ is F, Cl, Br, or I, 0<e≤10, 0<f≤10, 0<g≤15, and 0≤h≤20.

Specifically, in Chemical formula 4, ‘e’ may be greater than 0, 1 or more, 2 or more, 3 or more, 4 or more, 5 or more, and may be 10 or less, 9 or less, 8 or less, 7 or less, or 6 or less. In addition, in Chemical formula 4, ‘f’ may be greater than 0, 1 or more, 2 or more, 3 or more, 4 or more, 5 or more, and may be 10 or less, 9 or less, 8 or less, 7 or less, or 6 or less. In addition, in Chemical formula 4, ‘g’ may be greater than 0, 1 or more, 2 or more, 3 or more, 4 or more, 5 or more, 6 or more, or 7 or more, and may be 15 or less, 14 or less, 13 or less, 12 or less, 11 or less, 10 or less, or 9 or less. In addition, in Chemical formula 4, ‘h’ may be greater than 0, 2 or more, 4 or more, 6 or more, 8 or more, or 10 or more, 20 or less, 18 or less, 16 or less, 14 or less, or 12 or less.

According to an embodiment of the present disclosure, the solid electrolyte, which is comprised in the cathode active material layer, may be the same as or different from the solid electrolyte described above. Specifically, the solid electrolyte comprised in the solid electrolyte layer may be one or more selected from the group consisting of a sulfide-based solid electrolyte, an oxide-based solid electrolyte, a chloride-based solid electrolyte, and a polymer solid electrolyte, and more specifically, may be an azirodite-based solid electrolyte.

According to an embodiment of the present disclosure, when the cathode active material layer comprises a binder, the binder may be a component which supports the bonding between components, such as a cathode active material, a solid electrolyte, and a conductive material, of the cathode active material layer, and may be at least one selected from the group consisting of Poly(vinylidene fluoride-hexafluoropropylene) copolymer (PVDF-co-HEP), polyvinylidenefluoride, polyacrylonitrile, polymethylmethacrylate, polyvinyl alcohol, carboxymethylcellulose (CMC), starch, hydroxypropyl cellulose, regenerated cellulose, polyvinylpyrrolidone, tetrafluoroethylene, polyethylene, polypropylene, polyacrylic acid, ethylene-propylene-diene monomer (EPDM), sulfonated EPDM, styrene butylene rubber (SBR), and fluorine rubber.

According to an embodiment of the present disclosure, when the cathode active material layer comprises a conductive material, the conductive material may comprise various materials without being specially limited, as long as the materials have conductivity without inducing a chemical change in the all-solid state battery. Specifically, the conductive material may comprise graphite such as natural graphite or artificial graphite; carbon black, such as acetylene black, Ketjen black, channel black, furnace black, lamp black, or thermal black; conductive fiber, such as carbon fiber or metal fiber; carbon fluoride; metal powders, such as aluminum or nickel powders; conductive whisker such as zinc oxide or potassium titanate; a conductive metal oxide such as titanium oxide; and a conductive material, such as a polyphenylene derivative.

According to an embodiment of the present disclosure, the solid electrolyte layer 220 may selectively comprise a binder together with the solid electrolyte.

According to an embodiment of the present disclosure, the solid electrolyte of the solid electrolyte layer may be the same as or different from the solid electrolyte described above. Specifically, the solid electrolyte, which is comprised in the solid electrolyte layer, may be selected from the group consisting of a sulfide-based solid electrolyte, an oxide-based solid electrolyte, a chloride-based solid electrolyte, and a polymer solid electrolyte. More specifically, the solid electrolyte may be an azirodite-based solid electrolyte.

According to an embodiment of the present disclosure, when the solid electrolyte layer comprises a binder, the binder may be a component which supports the bonding between components, and may be at least one selected from the group consisting of Poly(vinylidene fluoride-hexafluoropropylene) copolymer (PVDF-co-HEP), polyvinylidenefluoride, polyacrylonitrile, polymethylmethacrylate, polyvinyl alcohol, carboxymethylcellulose (CMC), starch, hydroxypropyl cellulose, regenerated cellulose, polyvinylpyrrolidone, tetrafluoroethylene, polyethylene, polypropylene, polyacrylic acid, ethylene-propylene-diene monomer (EPDM), sulfonated EPDM, styrene butylene rubber (SBR), and fluorine rubber.

According to an embodiment of the present disclosure, the anode current collector 200 is not specially limited, as long as the anode current collector 200 comprises a metal having higher conductivity, is easily bonded to the cathode active material layer, and has no reactivity in the voltage range of the all-solid state battery. Specifically, the cathode current collector may be stainless steel, aluminum, nickel, titanium, fired carbon, or aluminum or stainless-steel surface-treated with carbon, nickel, titanium, and silver. In addition, the anode current collector may typically have a thickness ranging from 10 μm to 20 μm, and may be used in various forms, such as a film, a sheet, a foil, a net, a porous body, a foam, and a nonwoven fabric.

Hereinafter, another example of the present disclosure will be described in detail through embodiments. Following embodiments are provided only for the illustrative purpose to help the understanding of the present disclosure, and the scope of the present disclosure is not limited thereto.

### PREPARATION EXAMPLE

### Preparation Example 1

Three precursors of Li₂S, P₂S₅, and LiCl were dry mixed (through a ball milling process) at a molar ratio of 5:1:2. When dry mixing, planetary ball mill equipment, into which a zirconia ball (ZrO Ball) was put, was used, and rotated at a rate of 800 rpm for uniform mixing. Thereafter, the obtained mixed precursor was crystallized through heat treatment at 500° C. for 24 hours. The amorphous sulfide-based solid electrolyte expressed by the composition of Li₆PS₅Cl was prepared. The above process was performed under an atmosphere of Ar which is inert gas.

### Preparation Example 2

Three precursors of Li₂S, P₂S₅, and LiCl were dry mixed (through a ball milling process) at a molar ratio of 4.6:1:2.4. When dry mixing, planetary ball mill equipment, into which a zirconia ball (ZrO Ball) was put, was used, and rotated at a rate of 800 rpm for uniform mixing. Thereafter, the obtained mixed precursor was crystallized through heat treatment at 500° C. for 24 hours. The amorphous sulfide-based solid electrolyte expressed by the composition of Li_{5.8}PS_{4.8}Cl_{1.2} was prepared. The above process was performed under an atmosphere of Ar which is inert gas.

### Preparation Example 3

Three precursors of Li₂S, P₂S₅, and LiCl were dry mixed (through a ball milling process) at a molar ratio of 4:1:3. When dry mixing, planetary ball mill equipment, into which a zirconia ball (ZrO Ball) was put, was used, and rotated at a rate of 800 rpm for uniform mixing. Thereafter, the obtained mixed precursor was crystallized through heat treatment at 500° C. for 24 hours. The amorphous sulfide-based solid electrolyte expressed by the composition of Li_{5.5}PS_{4.5}Cl_{1.5} was prepared. The above process was performed under an atmosphere of Ar which is inert gas.

### EMBODIMENT AND COMPARATIVE EXAMPLE

### Embodiment 1

Amorphous sulfide-based solid electrolyte powders were obtained by performing a ball milling process with respect to the amorphous sulfide-based solid electrolyte prepared in Preparation example 1. When the ball milling process was performed, planetary ball-milled equipment, into which a zirconia ball (ZrO balls) was put, was used. After the ball milling process was performed, the SPS process was performed with respect to the amorphous sulfide-based solid electrolyte powders.

In this case, the SPS process was performed using SPS-211Lx equipment of Fuji Electronic Industrial Co. A graphite punch having a diameter of 10 mm and a graphite mold were prepared. The graphite mold was disposed on the graphite punch to form a reaction chamber. The graphite mold was disposed on the graphite punch coated with B.N Spray to form a reaction chamber. Then, 3 g of the sulfide-based solid electrolyte powders prepared according to Preparation Example 1 was put into the reaction chamber, and the upper portion of the reaction chamber was covered with the graphite punch coated with B.N Spray.

After mounting a thermocouple in a graphite mold (reaction chamber), the reaction chamber was fixed between the electrodes, by using a graphite spacer, and was adjusted to a vacuum atmosphere of 1 or less Pa while pressed at 50 Mpa through a hydraulic press. After a heating rate and a target temperature were set to 100° C./min and 350° C., respectively, heating was performed for 9 minutes, and the SPS process was performed for 9 minutes, when the temperature of the reaction chamber reached 350° C. In this case, the high frequency current and the high frequency voltage were maintained to 60 Hz at 500 A and 5 V.

After the SPS process was finished, the upper portion of the graphite punch was removed and cooled till 25° C. Thereafter, a crystalline sulfide-based solid electrolyte was obtained.

### Comparative Example 1

Amorphous sulfide-based solid electrolyte powders were obtained by performing a ball milling process with respect to the amorphous sulfide-based solid electrolyte prepared in Preparation example 1. When the ball milling process was performed, planetary ball-milled equipment, into which a zirconia ball (ZrO balls) was put, was used.

The amorphous sulfide-based solid electrolyte powders were heat-treated. In this case, the heat treatment was performed using FX-03 equipment of Korea Science, and 3 g of amorphous sulfide-based solid electrolyte powders was introduced into the reaction chamber. Therefore, the internal temperature of the reaction chamber was increased at the rate of 5° C./min while the heat treatment was performed. While the temperature was maintained to 500° C., the heat treatment was performed for 24 hours. The heat-treatment process was performed under an atmosphere of Ar which is inert gas.

After the heat treatment, in the state that the sulfide-based solid electrolyte was cooled to 25° C., the sulfide-based solid electrolyte was obtained.

### Comparative Example 2

The sulfide-based solid electrolyte was prepared by performing a ball milling process with respect to the amorphous sulfide-based solid electrolyte prepared in Preparation example 1. When the ball milling process was performed, planetary ball-milled equipment, into which a zirconia ball (ZrO balls) was put, was used.

### Embodiments 2 to 8, Comparative Examples 3, 6, and 7, and 10 to 12

The sulfide-based solid electrolytes were prepared according to Embodiments 2 to 8, Comparative examples 3, 6, and 7, and 10 to 12, in a manner the same as a manner of Embodiment 1, except that the type of the amorphous sulfide-based solid electrolyte and an SPS processing condition were different from those of Table 1, in Embodiment 1.

### Comparative Examples 4 and 8

The sulfide-based solid electrolytes according to comparative examples 4 and 8 were prepared in a manner the same as a manner of Comparative example 1, except that the type of the amorphous sulfide-based solid electrolyte was different from that of Table 1, in Comparative example 1.

### Comparative Examples 5 and 9

The sulfide-based solid electrolytes according to comparative examples 5 and 9 were prepared in a manner the same as a manner of Comparative example 2, except that the type of the amorphous sulfide-based solid electrolyte was different from that of Table 1, in Comparative example 2.

TABLE 1

| | | | Sin- | |
|---|---|---|---|---|
| | Sin- | | tering | Sintering |
| | tering | Amorphous sulfide- | temper- | processing |
| Classifica- | pro- | based solid | ature | time |
| tion | cessing | electrolyte | (° C.) | (min) |
| Embodiment 1 | SPS | Preparation example 1 | 350 | 9 |
| Embodiment 2 | SPS | Preparation example 1 | 390 | 9 |
| Embodiment 3 | SPS | Preparation example 1 | 400 | 10 |
| Embodiment 4 | SPS | Preparation example 1 | 500 | 10 |
| Embodiment 5 | SPS | Preparation example 2 | 430 | 10 |
| Embodiment 6 | SPS | Preparation example 2 | 480 | 10 |
| Embodiment 7 | SPS | Preparation example 3 | 480 | 10 |
| Embodiment 8 | SPS | Preparation example 3 | 500 | 10 |
| Comparative | Heat | Preparation example 1 | 500 | 24 hours |
| example 1 | treatment | | | |
| Comparative | Not | Preparation example 1 | — | — |
| example 2 | progressed | | | |
| Comparative | SPS | Preparation example 1 | 240 | 8 |
| example 3 | | | | |
| Comparative | Heat | Preparation example 2 | 500 | 24 hours |
| example 4 | treatment | | | |
| Comparative | Not | Preparation example 2 | — | — |
| example 5 | progressed | | | |
| Comparative | SPS | Preparation example 2 | 210 | 8 |
| example 6 | | | | |
| Comparative | SPS | Preparation example 2 | 350 | 9 |
| example 7 | | | | |
| Comparative | Heat | Preparation example 3 | 500 | 24 hours |
| example 8 | treatment | | | |
| Comparative | Not | Preparation example 3 | — | — |
| example 9 | progressed | | | |
| Comparative | SPS | Preparation example 3 | 170 | 7 |
| example 10 | | | | |
| Comparative | SPS | Preparation example 3 | 200 | 7 |
| example 11 | | | | |
| Comparative | SPS | Preparation example 3 | 300 | 8 |
| example 12 | | | | |

### Experimental Example 1

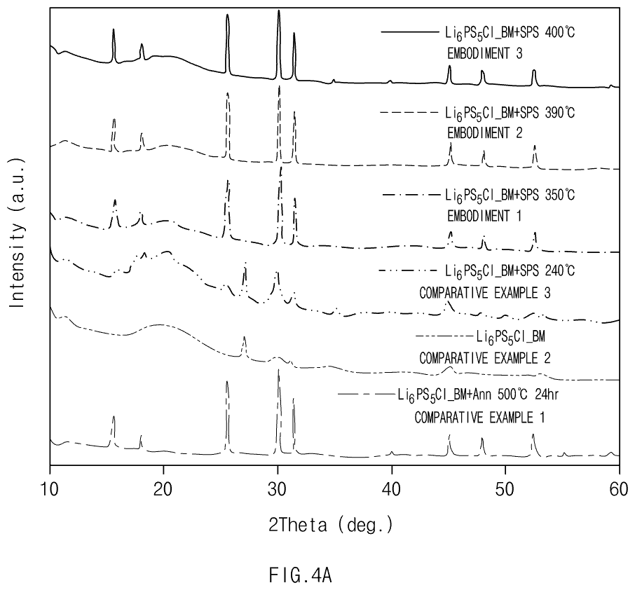

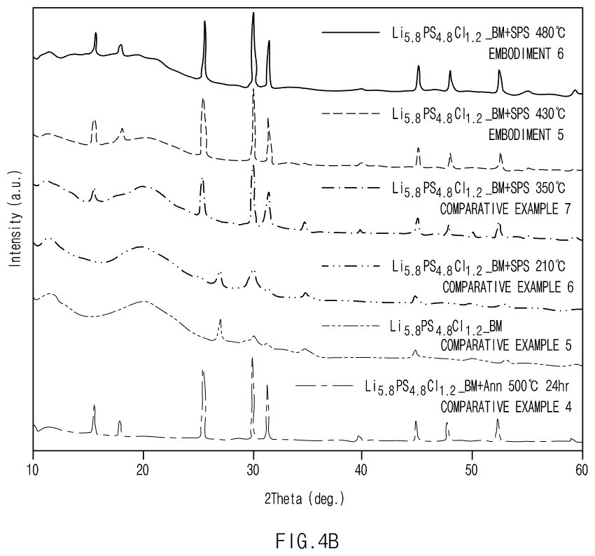

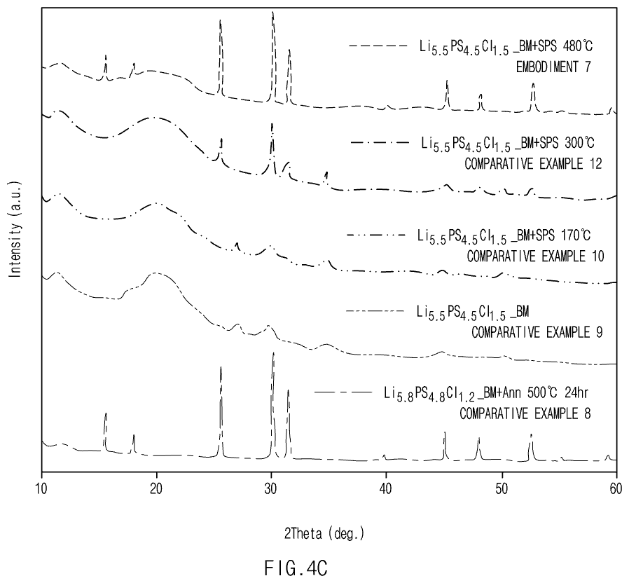

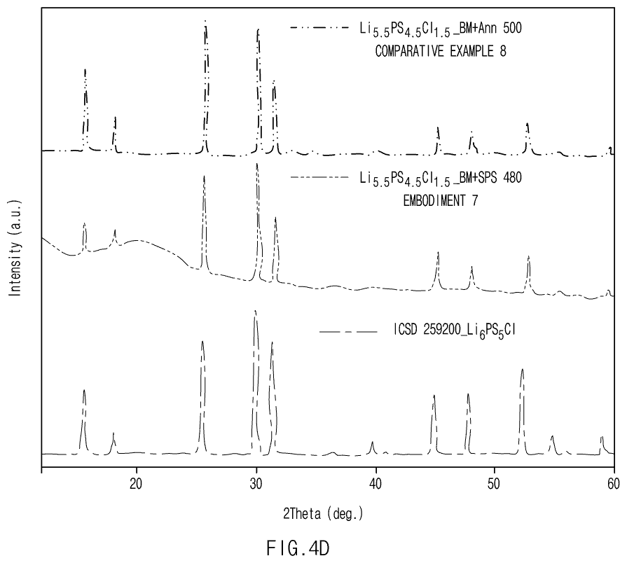

After XRD was measured with respect to the sulfide-based solid electrolyte expressed by Li₆PS₅Cl prepared according to Embodiments 1 to 3, and Comparative examples 1 to 3, the measurement data of the XRD is shown in FIG. 4A. A D8 advance equipment from Bruker was employed for X-ray diffraction (XRD) analysis, and 30 mg of sulfide-based solid electrolyte particles was obtained from each of the sulfide-based solid electrolyte powders according to Embodiments 1 to 3, and Comparative examples 1 to 3, and was analyzed through the X-ray diffraction analysis using a Cu-Kα ray (wavelength of 1.5148 Å) at an acceleration voltage of 40 kV/40 mA, at a scan rate of 0.02/sec in the 2θ range from 10° to 60°.

Accordingly, as illustrated in FIG. 4A, the sulfide-based solid electrolyte prepared according to Embodiment 1 had a smaller amount of Li₂S together with the azirodite-based solid electrolyte. The sulfide-based solid electrolyte prepared Embodiments 2 and 3 had only the azirodite-based solid electrolyte. Accordingly, it may be recognized in Embodiments 1 to 3 that high-crystalline azirodite-based solid electrolyte having no foreign substance was prepared.

To the contrary, the heat treatment was performed with respect to the sulfide-based solid electrolyte prepared according to Comparative example 1 at a higher temperature. However, the sulfide-based solid electrolyte prepared according to Comparative example 1 had the azirodite-based solid electrolyte and Li₂S and Li₃PS₄ representing foreign substances. Accordingly, the crystallinity of the azirodite-based solid electrolyte was degraded. In addition, as a sintering process was not performed with respect to the sulfide-based solid electrolyte prepared according to Comparative example 2 separately, the sulfide-based solid electrolyte prepared according to Comparative example 2 had only the amorphous sulfide-based solid electrolyte together with a small amount of Li₂S. Although the sulfide-based solid electrolyte prepared according to Comparative example 3 had the azirodite-based solid electrolyte due to a low sintering temperature, the sulfide-based solid electrolyte prepared according to Comparative example 3 had a smaller amount of Li₂S and Li₃PS₄ to exhibit the sulfide-based solid electrolyte having lower crystallinity.

### Experimental Example 2

After XRD was measured with respect to the sulfide-based solid electrolyte expressed by Li_{5.8}PS_{4.8}Cl_{1.2} prepared according to Embodiments 5 and 6, and Comparative examples 4 to 7, and the measurement data of the XRD is illustrated in FIG. 4B. A D8 advance equipment from Bruker was employed for X-ray diffraction (XRD) analysis, and 30 mg of sulfide-based solid electrolyte particles was obtained from each of the sulfide-based solid electrolyte powders according to Embodiments 5 and 6, and Comparative examples 4 to 7, and was analyzed through the X-ray diffraction analysis using a Cu-Kα ray (wavelength of 1.5148 Å) at an acceleration voltage of 40 kV/40 mA, at a scan rate of 0.02/sec in the 2θ range from 10° to 60°.

Accordingly, as illustrated in FIG. 4B, the sulfide-based solid electrolyte prepared according to Embodiment 5 had a smaller amount of Li₂S together with the azirodite-based solid electrolyte. The sulfide-based solid electrolyte prepared Embodiment 6 had only the azirodite-based solid electrolyte. Accordingly, it may be recognized in Embodiments 5 to 6 that high-crystalline azirodite-based solid electrolyte having no foreign substance was prepared.

To the contrary, the heat treatment was performed with respect to the sulfide-based solid electrolyte prepared according to Comparative example 4 under the condition of a higher temperature for the azirodite-based solid electrolyte. However, the sulfide-based solid electrolyte prepared according to Comparative example 4 had the azirodite-based solid electrolyte and Li₂S and Li₃PS₄ representing foreign substances, so the crystallinity of the azirodite-based solid electrolyte was degraded. In addition, as a sintering process was not performed with respect to the sulfide-based solid electrolyte prepared Comparative example 5 separately, the sulfide-based solid electrolyte prepared according to Comparative example 5 had only the amorphous sulfide-based solid electrolyte together with a small amount of Li₂S. The sulfide-based solid electrolyte prepared according to Comparative example 6 had the amorphous sulfide-based solid electrolyte together with a smaller amount of Li₂S representing foreign substances, due to a low sintering temperature, which are similar to Comparative example 5. In addition, although the sulfide-based solid electrolyte prepared according to Comparative example 7 had the azirodite-based solid electrolyte, a smaller amount of Li₂S and Li₃PS₄ representing foreign substances was present together. Accordingly, it may be recognized that the prepared sulfide-based solid electrolyte according to Comparative example 7 exhibited the lower crystallinity.

### Experimental Example 3

After XRD was measured with respect to the sulfide-based solid electrolyte expressed by Li_{5.5}PS_{4.5}Cl prepared according to Embodiment 7 and Comparative examples 8 to 10 and 12, and the measurement data of the XRD is illustrated in FIGS. 4C and 4D. A D8 advance equipment from Bruker was employed for X-ray diffraction (XRD) analysis, and 30 mg of sulfide-based solid electrolyte particles was obtained from each of the sulfide-based solid electrolyte powders according to Embodiment 7 and Comparative examples 8 to 10 and 12, and was analyzed through the X-ray diffraction analysis using a Cu-Kα ray (wavelength of 1.5148 Å) at an acceleration voltage of 40 kV/40 mA, at a scan rate of 0.02/sec in the 20 range from 10° to 60°.

Accordingly, as illustrated in FIGS. 4C and 4D, the sulfide-based solid electrolyte prepared according to Embodiment 7 had only the azirodite-based solid electrolyte. Accordingly, it may be recognized in Embodiment 7 that azirodite-based solid electrolyte having higher crystallinity was prepared without foreign substances.

To the contrary, the heat treatment was performed with respect to the sulfide-based solid electrolyte prepared according to Comparative example 8 under the condition of a higher temperature for the azirodite-based solid electrolyte. However, the sulfide-based solid electrolyte prepared according to Comparative example 8 had the azirodite-based solid electrolyte and Li₂S and Li₃PS₄ representing foreign substances. Accordingly, the crystallinity of the azirodite-based solid electrolyte was degraded. In addition, as a sintering process was not performed with respect to the sulfide-based solid electrolyte prepared according to Comparative example 9 separately, the sulfide-based solid electrolyte prepared according to Comparative example 9 had only the amorphous sulfide-based solid electrolyte together with a small amount of Li₂S. Although the sulfide-based solid electrolyte prepared according to Comparative example 10 had amorphous sulfide-based solid electrolyte and a smaller amount of LI₂S representing foreign substances, due to a low sintering temperature, which is similar to Comparative example 9. In addition, the sulfide-based solid electrolyte prepared according to Comparative example 12 had azirodite-based solid electrolyte but had a smaller amount of Li₂S and Li₃PS₄ together. Accordingly, it may be recognized that the prepared sulfide-based solid electrolyte exhibited the lower crystallinity.

### Experimental Example 4

150 mg of the solid electrolyte powders prepared in each of Embodiments 3, 6 and 7, and Comparative examples 3, 6, 8, and 11 was introduced into an SUS mold having a diameter of 13 mm. Potentiostat was connected to the SUS mold while the mold was mounted on a press machine together with the insulating PEEK. After an electrolyte structure was sufficiently densified as the electrolyte structure was pressed at 45 MPa, a pressure cell was fastened with a force of 100 N·m, and then an AC impedance was measured in the measurement frequency ranging from 1 Hz to 1 MHz. Ion conductivity was calculated from the measured resistance through a Nyquist plot and is illustrated in following Table 2. All measurements were performed in a drying room having a temperature of 25° C. and a relative humidity of 1%.

TABLE 2

| | Amorphous sulfide- | Ion conductivity | |
|---|---|---|---|
| Classification | based solid electrolyte | (mS/cm) | Ratio |
| Embodiment 3 | Preparation example 1 | 0.49 | 4.9 |
| Comparative | Preparation example 1 | 0.1 | |
| example 3 | | | |
| Embodiment 6 | Preparation example 2 | 1.63 | 12.5 |
| Comparative | Preparation example 2 | 0.13 | |
| example 6 | | | |
| Embodiment 7 | Preparation example 3 | 4.47 | 149 |
| Comparative | Preparation example 3 | 0.03 | |
| example 11 | | | |
| Comparative | Preparation example 3 | 2.27 | — |
| example 8 | | | |

As shown in Table 2, it may be recognized that the sulfide-based solid electrolytes prepared according to Embodiments 3, and 6 and 7 and subjected to the SPS process had high crystalline azirodite-based solid electrolytes exhibited ion conductivity improved by about 4.9, 12.5, and 149 times, when compared to the sulfide-based solid electrolytes prepared according to Comparative Examples 3, 6, and 11 and not subjected to the SPS process. In addition, it may be recognized that the sulfide-based solid electrolytes prepared according to Embodiment 7 exhibited ion conductivity improved by about 1.96 times, when compared to the sulfide-based solid electrolyte prepared according to Comparative example 8. Accordingly, it may be recognized that the high crystalline azirodite-based solid electrolyte was obtained through the SPS process, when compared to the heat treatment, even if a similar temperature condition was applied.

### Experimental Example 5

Composite cathode powders were prepared by mixing 80 wt % of LiNi_{0.8}Co_{0.1}Mn_{0.1}O₂ cathode active material powders, 2 wt % of carbon black powders serving as a conductive material, and 18 wt % of Li₆PS₅Cl solid electrolyte powders. Next, the sulfide-based solid electrolyte prepared in Comparative example 11 was used and pressed at pressure of 10 MPa to form a solid electrolyte pellet layer. Thereafter, the composite cathode powders and Al foil were sequentially loaded onto the solid electrolyte pellet layer and pressed at 45 MPa. In addition, Li foil and Ni foil were placed on opposite side of the solid electrolyte pellet layer and the result was coupled to a pressure cell to prepare a half-cell.

The half-cell was charged at 25° C. to 4.3 V at 0.1 C and then discharged at a constant current of 0.1 C to 2.5 V to perform one cycle. Then, the discharging capacity and voltage of the half-cell were measured.

Subsequently, after performing 4 cycles of the same charging and discharging processes as described above, the discharge capacity and voltage were measured.

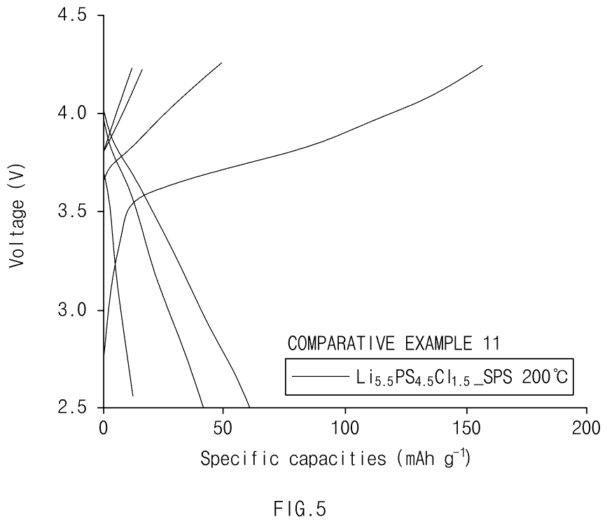

As illustrated in FIG. 5, it may be recognized that the half-cell comprising the sulfide-based solid electrolyte prepared according to Comparative example 11 are neither charged nor discharged normally, as the charging/discharging cycle was repeatedly performed.

### Experimental Example 6

The half-cell was prepared in a manner the same as a manner of Experimental example 5, except that the sulfide-based solid electrolyte prepared according to Comparative example 11 was substituted with sulfide-based solid electrolyte prepared according to Embodiments 4 and 8, and Comparative examples 1 and 8.

### 1. Evaluation of Output Characteristics

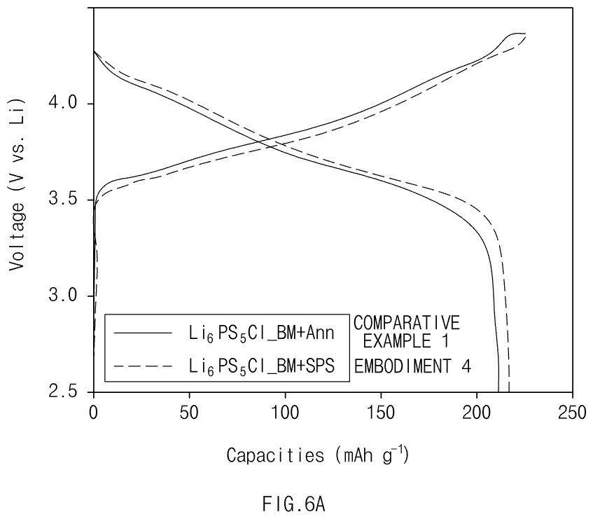

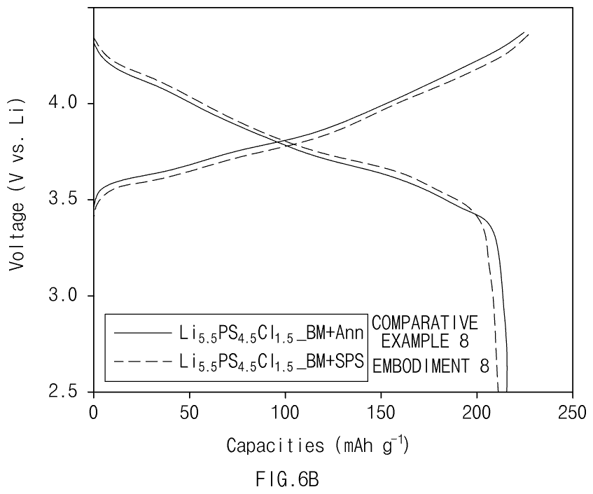

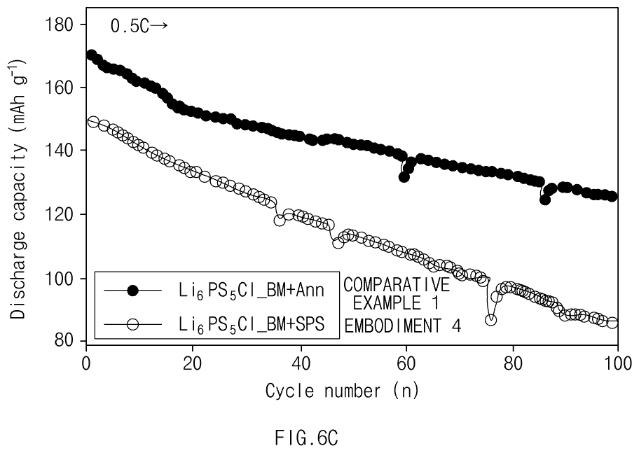

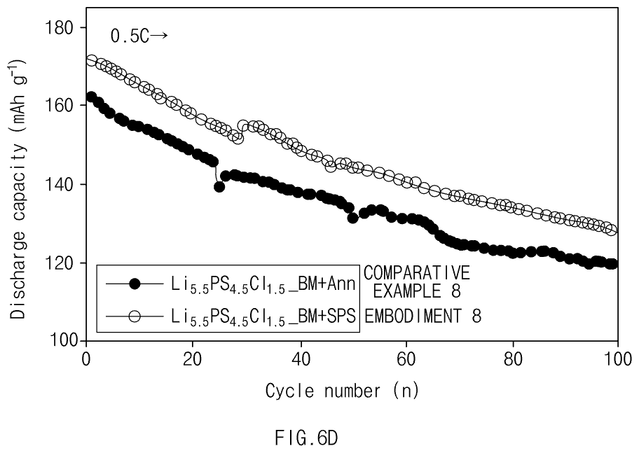

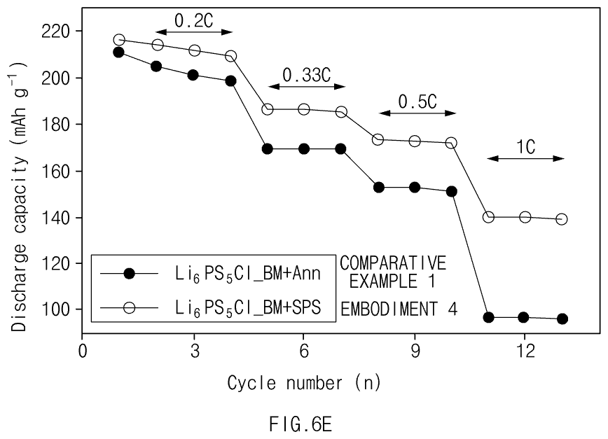

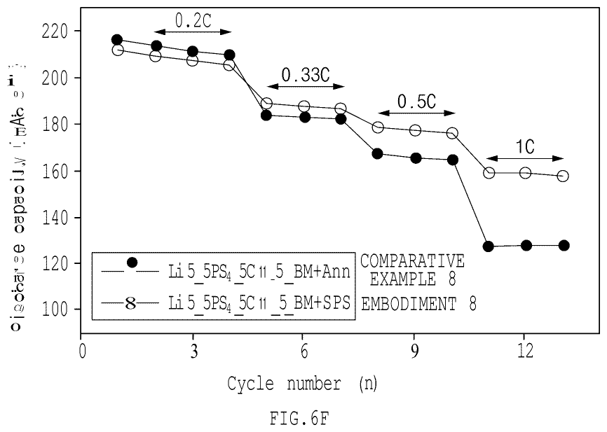

The half-cell was charged at 25° C. to 4.3 V at 0.1 C and then discharged at a constant current of 0.1 C to 2.5 V to perform one cycle. Then, an initial charging capacity and an initial discharging capacity were measured, initial efficiency was calculated as in following Equation 1, and the results are shown in following Table 3, and FIGS. 6A and 6B.

$$Initial efficiency ( \% ) = Discharging capacity / Charging capacity \qquad [ Equation 1 ]$$

### 2. Evaluation of Lifespan Characteristics

The half-cell was charged at 25° C. to 4.3 V at 0.5 C and then discharged at a constant current of 0.5 C to 2.5 V to perform one cycle. Then, an initial discharging capacity was measured, and the result is shown following Table 3.

Subsequently, after performing the charging and discharging processes as described above were in 100 cycles, a discharging capacity was measured, and the cycle efficiency was calculated 100 times. Thereafter, a durability retention rate was calculated as expressed in Equation 2, and the results are illustrated in following Table 3, and FIGS. 6C and 6D.

$$Durability retention rate ( \% ) = Capacity after 100 cycles / Initial capacity * 100 ( \% ) \qquad [ Equation 2 ]$$

### 3. Evaluation of C-Rate Characteristics

The processes, in which the half-cell was charged at 25° C. to 4.3 V at 0.2 C and then discharged at a constant current of 0.2 C to 2.5 V, were performed in two cycles. Thereafter, the half-cell was charged in 0.2 C and discharged while changing the C-rate to 0.33 C, 0.5 C, and 1.0° C. step by step, thereby evaluating the C-rate characteristics. The results are shown in Table 3, and FIGS. 6E and 6F.

TABLE 3

| | | | | | Lifespan | | | | | |
|---|---|---|---|---|---|---|---|---|---|---|
| | | | | | characteristics | | | | | |
| | Amorphous | Output characteristics | | | Initial | | | | | |
| | sulfide-based | Charging | Discharging | Initial | discharging | Durability | C-rate characteristics | | | |
| | solid | capacity | capacity | efficiency | capacity | retention | 0.2 C | 0.33 C | 0.5 C | 1 C |
| Classification | electrolyte | (mAh/g) | (mAh/g) | (%) | (mAh/g) | rate (%) | (mAh/g) | (mAh/g) | (mAh/g) | (mAh/g) |
| Embodiment 4 | Preparation | 229.2 | 216.4 | 94.4 | 170.2 | 73.9 | 211.8 | 186.7 | 172.9 | 140.2 |
| | example 1 | | | | | | | | | |
| Comparative | Preparation | 224.2 | 211.3 | 94.2 | 149.9 | 56.9 | 201.4 | 169.8 | 152.1 | 97.0 |
| example 1 | example 1 | | | | | | | | | |
| Embodiment 8 | Preparation | 226.9 | 210.8 | 92.9 | 176.9 | 74.0 | 206.5 | 187.2 | 176.9 | 158.2 |
| | example 3 | | | | | | | | | |
| Comparative | Preparation | 228.6 | 215.2 | 94.1 | 165.2 | 73.3 | 210.8 | 182.5 | 165.2 | 127.8 |
| example 8 | example 3 | | | | | | | | | |

Referring to Table 3, FIGS. 6A to 6F, it may be recognized that half-cells manufactured using the sulfide-based solid electrolytes prepared according to Embodiments 4 and 8 were more excellent in output characteristics, lifespan characteristics, and C-rate characteristics, as compared to the half-cells manufactured using the sulfide-based solid electrolytes prepared according to Comparative examples 1 and 8. Accordingly, it may be recognized that the SPS process allows the high crystalline azirodite-based solid electrolyte to be formed in a stabler crystal structure, when compared to the heat treatment sintering process, on the assumption that a sintering process is performed at a similar temperature.

As described above, according to the present disclosure, in the method for preparing the sulfide-based solid electrolyte, the azirodite-based solid electrolyte for the all-solid state battery, which exhibits excellent ion conductivity, may be easily prepared only through the SPS process for the shorter time period.

Hereinabove, although the present disclosure has been described with reference to exemplary embodiments and the accompanying drawings, the present disclosure is not limited thereto but may be variously modified and altered by those skilled in the art to which the present disclosure pertains without departing from the spirit and scope of the present disclosure claimed in the following claims.

What is claimed is:

1. A method for preparing a sulfide-based solid electrolyte, the method comprising:
synthesizing an amorphous sulfide-based solid electrolyte; and
obtaining a crystalline sulfide-based solid electrolyte by subjecting the amorphous sulfide-based solid electrolyte to a spark plasma sintering (SPS) process performed at a reaction temperature of about 360° C. to 600° C.

2. The method of claim 1, wherein the SPS process is performed at a reaction temperature of about 400° C. to about 500° C.

3. The method of claim 1, wherein the SPS process is performed at pressure of about 1 MPa to about 150 MPa.

4. The method of claim 1, wherein the SPS process is performed at pressure of about 20 MPa or more and about 90 MPa or less.

5. The method of claim 1, wherein the SPS process is performed for a time period of about 1 minute or more and about 15 minutes or less.

6. The method of claim 1, wherein is the amorphous sulfide-based solid electrolyte is synthesized by performing a milling process for a source material, which comprises a lithium sulfide, a sulfide-based source material, and a halogen compound, to form powders, and performing a mixing process and a heat-treatment process for the powders.

7. The method of claim 1, wherein the crystalline sulfide-based solid electrolyte comprises an azirodite-type sulfide-based solid electrolyte.

8. The method of claim 1, wherein the crystalline sulfide-based solid electrolyte comprises a sulfide-based solid electrolyte represented by following Chemical formula 1, 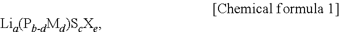
in which in Chemical formula 1,
‘M’ is at least one selected from the group consisting of Sb, Sn, Ge, Si, Nb, Ni, Ga, and Al,
‘X’ is at least one selected from the group consisting of F, Cl, Br, and I,
3.0≤a≤8.0, 0<b≤2.0, 2.0≤c≤7.0, 0≤d≤1.0, and 0<e≤2.0, and
‘b’ is greater than ‘d’.

9. The method of claim 1, wherein the crystalline sulfide-based solid electrolyte comprises a sulfide-based solid electrolyte represented by following Chemical formula 2, 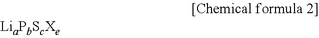
in which, in Chemical formula 2,
‘M’ is at least one selected from Sb, Sn, Ge, Si, Nb, Ni, Ga, and Al,
‘X’ is at least one selected from F, Cl, Br and I, and
$$4.5 \leq a \leq 7.0 , 0.7 \leq b \leq 1.8 , 4.0 \leq c \leq 6. , and 0.5 \leq e \leq 2.0 .$$

10. A crystalline sulfide-based solid electrolyte having an argyrodite crystal structure,
wherein the electrolyte is obtained by subjecting an amorphous sulfide-based solid electrolyte precursor to a spark-plasma-sintering (SPS) process carried out at a temperature of about 360° C. to about 600° C., under a pressure of about 1 MPa to about 150 MPa, for 1 minute to 15 minutes.

11. The electrolyte of claim 10, wherein the SPS process is carried out at a reaction temperature of about 400° C. to about 500° C.

12. The electrolyte of claim 10, wherein the SPS process is carried out at a pressure of about 2 MPa to about 90 MPa.

13. The crystalline sulfide-based solid electrolyte of claim 10, wherein the electrolyte is represented by following Chemical formula 1, 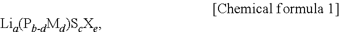
in which in Chemical formula 1,
‘M’ is at least one selected from the group consisting of Sb, Sn, Ge, Si, Nb, Ni, Ga, and Al,
‘X’ is at least one selected from the group consisting of F, Cl, Br, and I,
3.0<a≤8.0, 0<b≤2.0, 2.0≤c≤7.0, 0≤d≤1.0, and 0<e≤2.0, and
‘b’ is greater than ‘d’.

14. The crystalline sulfide-based solid electrolyte of claim 10, wherein the electrolyte is represented by following Chemical formula 2,
LiₐP_{b}S_{c}Xₑ
in which, in Chemical formula 2,
‘M’ is at least one selected from Sb, Sn, Ge, Si, Nb, Ni, Ga, and Al,
‘X’ is at least one selected from F, Cl, Br and I, and
$$4.5 \leq a \leq 7.0 , 0.7 \leq b \leq 1.8 , 4.0 \leq c \leq 6. , and 0.5 \leq e \leq 2.0 .$$

15. The crystalline sulfide-based solid electrolyte of claim 10, wherein the electrolyte comprises Li₆PS₅Cl.

16. An all-solid-state secondary battery comprising:
an anode current collector;
a solid-electrolyte later that includes the crystalline sulfide-based solid electrolyte according to claim 10, and
a cathode active-material layer disposed in contact with the solid-electrolyte layer.

17. The battery of claim 16, wherein the cathode-active material layer comprises LiNi_{0.8}Co_{0.1}Mn_{0.1}O₂.

18. The battery of claim 16, wherein the solid-electrolyte layer and the cathode active-material layer are laminated by pressing at about 45 MPa.

19. The battery of claim 16, configured as a half-cell that further includes a lithium metal foil anode.

20. The battery of claim 16, wherein an initial efficiency (discharging capacity/charging capacity) of about 90% or greater is obtained.
